(19) United States
(12) Patent Application Publication
(10) Pub. No.: US 2007/0050092 A1
(43) Pub. Date: Mar. 1, 2007

(54) Event-based library process design

(75) Inventors: Kirk Kenyon, Boulder Creek, CA (US); Eric Low, Berkeley, CA (US); Adam Safir, Berkeley, CA (US)

Correspondence Address: SYMYX TECHNOLOGIES INC;LEGAL DEPARTMENT, 415 OAKMEAD PARKWAY, SUNNYVALE, CA, 94085, US

(73) Assignee: Symyx Technologies, Inc., Santa Clara, CA (US)

(21) Appl. No.: 11/503,725

(22) Filed: Aug. 14, 2006

Related U.S. Application Data
(60) Provisional application No. 60/707,857, filed on Aug. 12, 2005.

(51) Int. Cl. G06F 19/00

(52) U.S. Cl. 700/266; 702/22

(57) ABSTRACT

Systems, methods and apparatus for designing a process to be performed at regions of an experiment library, the process involving the application of components at the library regions. Components are associated with regions of the experiment library. Each of the components represents a material or process parameter to be applied at the regions. A plurality of experiment stages are defined, each having one or more associated event types that are selected from predetermined event types and define a start condition for the corresponding stage. For each of the library regions, the components are associated with one or more of the experiment stages. A plurality of component profiles are generated, which represent processes to be performed at the various regions, and which describe the application over time of one or more of the components associated with a corresponding region or regions according to the associated experiment stages.

### CROSS-REFERENCE TO RELATED APPLICATIONS

This application claims the benefit of U.S. Provisional Application No. 60/707,857, filed on Aug. 12, 2005, which is incorporated by reference herein.

### BACKGROUND

This invention relates to techniques for designing automated and semi-automated processes. There is currently a tremendous amount of activity directed toward the discovery and optimization of materials and material systems such as phosphors, polymers, pharmacological compounds, semiconducting solids, and devices and the like. These new materials are typically useful because they have superior values for one or several properties, such as electrical conductivity, color, bio-inertness, fabrication cost, or any other property. A variety of fields (pharmacology, chemistry, materials science) focus on the development of new materials and devices with superior properties. Unfortunately, even though the chemistry of both small molecules and extended solids has been extensively explored, few general principles have emerged that allow one to predict with certainty the composition, structure, and reaction pathways for synthesis of such materials. New materials are typically discovered through experimentation, rather than designed from existing principles.

A common challenge is understanding how two materials actually differ from each other. Any two materials might be similar in one or many ways (e.g., composition) but different in many other ways. Thus, the properties of one material might be “better” (for a particular purpose) than those of another material for any number of reasons. One goal of experimental science is determining how properties vary with different parameters. In this sense, a parameter is any variable whose value can change in either a continuous or discontinuous fashion. Parameters can include concentrations of different chemical species (e.g., elements, compounds, solvents), temperature, annealing time, molecular weight, exposure time to radiation, process sequence or any other variable. Experimental studies typically examine the variation of a given property (e.g., smell) with a measured parameter (e.g., molecular weight), often with the implicit assumption that all other parameters are held constant (i.e., their values are identical for the compared samples). In the ideal case, two materials only differ in one parameter, and variation in the measured property is construed to be caused by variation in this parameter.

Unfortunately, it is difficult or impossible to completely determine how two materials are “different”. While variation in a given parameter (e.g., chemical composition) might be fairly obvious (e.g., one sample has 20% more nitrogen than the other), variation in another parameter might remain hidden (e.g., one sample has a slightly preferred grain orientation, vs. another sample's random orientation). The challenge is determining which parameters have a significant effect on the property of interest. This challenge requires the examination of the effects of many different parameters on the desired properties. Variation in each of these parameters creates a parameter space: a high-dimensional space defined by all the relevant parameters that describe a material. A single material is thus defined by its coordinates within this parameter space—the values for each of these parameters for the given material. The goal of materials development is finding the coordinates of the material with the best set of desired properties. The commonly used analogy “looking for a needle in a haystack” can loosely describe this process: the parameter space is the “haystack”, and the material(s) with the best set of properties is (are) the needle(s).

### SUMMARY

The invention features techniques for designing processes for parallel or high-throughput experiments. In general, in one aspect, the invention provides computer-implemented systems, methods and apparatus, including computer program products, implementing techniques for designing an automated or semi-automated process to be performed at one or more regions of an experiment library, where the process involves the application of a plurality of components at the one or more regions. The techniques include associating one or more components with each of a plurality of regions of the experiment library, defining a plurality of experiment stages and a start condition for each of the plurality of experiment stages, and for each of the plurality of regions of the experiment library, associating each of the associated components with one or more of the experiment stages to generate a plurality of component profiles representing processes to be performed at the regions of the experiment library. Each of the components represents a material or process parameter to be applied at the associated regions. Each component profile describes the application over time of one or more of the components associated with a corresponding region or regions according to the associated experiment stages.

Particular implementations can include one or more of the following features. The start condition for one or more of the plurality of experiment stages can be defined by a clock event that specifies a start condition based on a specified time in the process. The start condition for one or more of the plurality of experiment stages can be defined by a stage event that specifies a start condition based on the state of another stage in the plurality of experiment stages. The start condition for one or more of the plurality of experiment stages can be defined by a process data event that specifies a start condition based on a target value of a parameter being monitored during the process. The start condition for one or more of the plurality of experiment stages can be defined by a manual user event that specifies a start condition based on a specified user input. Each of the plurality of experiment stages can have one or more associated event types selected from a plurality of predetermined event types, where the one or more event types defining a start condition for the corresponding stage. The plurality of predetermined event types can include a clock event, a stage event, a process data event, or a manual user event.

Defining the experiment stages can include defining one or more experiment stages having a compound start condition defined by a plurality of event types. Associating the one or more components with the plurality of regions can include receiving a plurality of component mappings, where each mapping assigns an amount or amounts of one of the components to one or more of the plurality of regions, and associating the components with the experiment stages can include, for each of the component mappings and each of the corresponding regions, associating the corresponding component amount or amounts with one or more of the experiment stages. Associating the components with the experiment stages can include, for a given region, associating a first amount of one of the components with a first stage of the plurality of experiment stages and a second amount of the component with a second stage of the plurality of experiment stages.

The experiment library can include a plurality of library members, where each library member represents a location at which an experiment in a set of experiments can be performed, and each region of the experiment library can represent a single library member or a group of library members. The techniques can include displaying a graphical representation of one or more of the component profiles to a user, and/or generating a process design comprising electronic data representing the components, experiment stages and processes. The techniques can include executing a set of experiments by applying the components to the regions of the experiment library according to the component profiles, such that each component associated with a given region of the experiment library is applied to the given region according to the start conditions of the stages associated with the component. Executing the set of experiments can include translating the process design into instructions for one or more automated devices, and executing the set of experiments using the one or more automated devices according to the instructions.

The plurality of experiment stages can include an experiment stage having a process data event type having a start condition based on a target value of a specified parameter. Executing the set of experiments can include monitoring the specified parameter for one or more of the regions during execution of the set of experiments, and applying the component or components associated with the experiment stage according to the corresponding component profile when a monitored value of the specified parameter reaches the target value. Applying the component or components can include applying the component or components associated with the experiment stage to the corresponding regions according to the corresponding component profile only when a monitored value of the specified parameter reaches the target value for all members of the experiment library. Applying the component or components can include applying the component or components associated with the experiment stage to a given region according to the corresponding component profile when a monitored value of the specified parameter reaches the target value for the given region of the experiment library.

The invention can be implemented to realize one or more of the following advantages, alone or in the various possible combinations. Defining associations between components, elements (or regions) of a multi-element library, and process stages can simplify the design of complex processes or processes that will be performed repeatedly but with parameters that may vary over time. The ability to define stage dependencies based on different event types provides for flexibility in the design of complex processes, including processes that incorporate automated, real-time feedback control. Such feedback control can enable the reactor system to automatically modify an ongoing reaction process to match user-specified targets, which can significantly reduce the time needed to find the ideal process. Feedback control can also provide for additional dimensions of variation in a combinatorial set of experiments, by facilitating the use of properties measured during the reaction to identify correlations between measured values and reaction outcome.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a system for designing and controlling a process for a set of parallel and/or high-throughput experiments according to one aspect of the invention.

FIG. 2 is flow diagram illustrating a method for generating a process design for a set of experiments according to one aspect of the invention.

FIGS. 3A-3I are examples of a user interface illustrating one implementation of a computer program product configured to perform the method illustrated in FIG. 2.

Like reference symbols in the various drawings indicate like elements.

### DETAILED DESCRIPTION

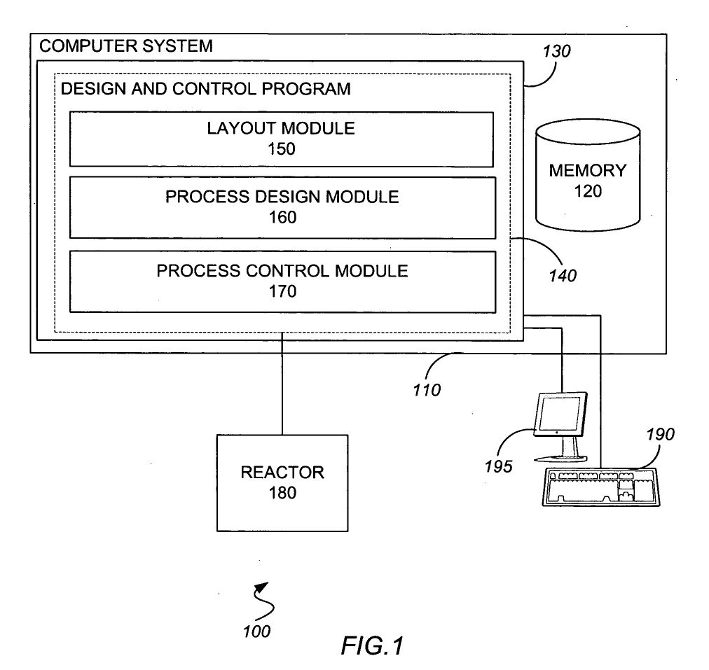

The invention provides methods and apparatus for designing a process for a set of parallel and/or high-throughput experiments. FIG. 1 illustrates one implementation of an experiment design and control system 100 that includes a general-purpose programmable digital computer system 110 of conventional construction, including a memory 120 and a processor 130 running a design and control program 140, which features a library layout module 150, a process design module 160 and a process control module 170. System 100 also includes one or more external devices 180 that will be used to execute the set of experiments under control of process control module 170. In particular implementations, devices 180 can include automated or semi-automated laboratory instruments, such as chromatographs, spectrometers, diffractometers and the like, as well as automated and semi-automated materials-handling devices such as multi-well reactors, and liquid- or solid-handling robots. System 100 also includes input devices 190, such as a keyboard or mouse, output devices 195, such as a conventional display monitor, and, optionally, conventional communications hardware and software by which computer system 110 can be connected to other computer systems, such as a computer system controlling one or more materials handling apparatus (e.g., a synthesis robot, vapor deposition equipment or the like). In some implementations, design and control program 140 implements a graphical user interface that is displayed to a user over a display device such as a monitor. Optionally, system 100 can be implemented as part of a process control and data management system, as described in U.S. Pat. No. 6,658,429, WO 02/054188, and WO 01/79949, all of which are incorporated by reference herein. Although FIG. 1 illustrates system 100 as being implemented on a single computer system, the functions of system 100 can be distributed across multiple computer systems, such as on a network. A typical user of system 100 is a research chemist or materials scientist.

Experiments are performed, for example, using automated devices 180 to perform one or more synthesis, formulation, sample-handling, characterization and/or screening operations on a set of materials such as a library of materials. A library of materials is an arrangement of members, or library elements, typically two or more members, generally containing some variance in material composition, amount, reaction conditions, and/or processing conditions. In the techniques described herein, a library is represented as an array containing a plurality of elements that correspond to library members. In typical implementations, libraries are represented as a two dimensional matrix of elements, such as square or rectangular matrices. However, libraries can be represented or prepared in any convenient shape, such as square, rectangle, circle, triangle or the like, and in one, two or three dimensions, depending, for example, on the underlying chemistry or apparatus involved.

A single library element, in turn, represents a single location or position in a library that contains one set of materials subject to one set of reaction or processing conditions. A material can be, for example, an element, chemical composition, biological molecule, or any of a variety of chemical or biological components. The particular materials, compounds or chemistries involved are not critical; instead, the methods, computer programs and systems described are broadly applicable to a wide variety of library types and chemistries. Thus, in particular implementations, libraries used in system 100 can include, for example, libraries of biomaterials, organics, organometallics, inorganics, intermetallics, metal alloys, or ceramics, and in particular heterogeneous and homogeneous catalysts, specialty application polymers and formulations of organic and inorganic materials including, for example mixtures of polymers and/or bioactive materials with any other materials.

As used in this specification, experiments typically involve the preparation and/or processing of materials in a library of materials, and the subsequent measurement and/or analysis of one or more variables or properties of each material in order to characterize the materials, or to screen the materials for desirable properties. In particular, the techniques and apparatus described herein can be used in the performance of experiments directed to the discovery of new and useful compositions, such as superconductors, zeolites, magnetic materials, phosphors, catalysts, thermoelectric materials, high and low dielectric materials, and other materials of interest. Such experiments can involve the measurement of a variety of properties, including without limitation electrical, thermal, mechanical, morphological, optical, magnetic, chemical, conductivity, super-conductivity, resistivity, thermal conductivity, anisotropy, hardness, crystallinity, optical transparency, magnetoresistance, permeability, frequency doubling, photoemission, coercivity, dielectric strength, or other useful properties, and can yield data in the form of, for example, electrical voltages and resistivity, photon counts, and frequency and wavelength of electromagnetic radiation, any of which could be measured on a time-varying basis or as a combination of each other in the form of dependent-independent variables. The techniques described herein can be used to define a wide variety of different types of processes, ranging from processes within a discrete synthesis experiment to more broader processes describing complex workflows—for example, synthesis of an active ingredient, followed by formulation, characterization and screening.

Libraries can include physical arrays of materials, with different materials located at different regions of a substrate. In one implementation, each library includes two or more library elements, each of which may be represented as a region in an arrangement (e.g., an array) of one or more regions. In particular implementations, a library can include four, ten, twenty, ninety-six or more library elements. The library elements may, but need not necessarily, correspond to locations on a physical substrate (such as a microtiter plate, wafer or the like) on which the library was or will be created. Thus, although the library may correspond to the geometry of the ultimate physical substrate, it may also represent a collection of library elements on a more conceptual level. Details of library design and preparation are further discussed in WO 00/23921 and WO 00/67086, and in U.S. Pat. Nos. 5,776,359, 5,959,297, 5,985,356, 6,030,917, 6,034,775, and 6,149,882, and U.S. Publication No. 2003/0149933 A1, each of which is incorporated by reference herein.

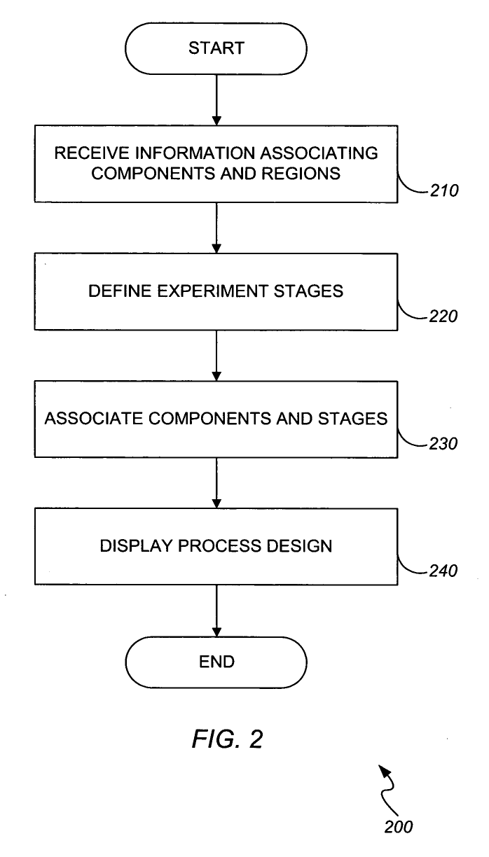

FIG. 2 illustrates a general method 200 for generating a process design for a set of experiments. The method begins when process design module 160 obtains layout information associating one or more components with each of a plurality of regions of a library array (step 210). A component is a chemical entity (e.g., a particular chemical element, compound or mixture of chemicals) or a parameter (e.g., an external process parameter such as pressure, temperature, time, flow rate, voltage, current, stirring speed, data acquisition rate or the like) that can be applied to elements of a library array. The layout information will typically include information for a number of different chemical entities to be deposited in different amounts at various locations across the library array, as well as information for a number of different process parameters to be applied, often in varying amounts, to the materials thus deposited. In some implementations, the layout information can associate components with individual elements of the library array (i.e., the regions can correspond to individual library members). Alternatively, or in addition, library elements can be grouped to define regions that correspond to multiple library members. Thus, in one example the layout information may define amounts of each of a plurality of chemicals (or mixtures of chemicals) to be deposited in each element of a library array, and may define temperature and pressure settings (i.e., “amounts” of temperature and pressure) and data monitoring criteria (e.g., when monitoring of particular parameters will start and stop, and at what rate data will be collected) to be applied to each of a plurality of groups of elements that correspond to multi-well reactor block modules of a parallel reactor such as that described in U.S. Pat. No. 6,306,658, which is incorporated by reference herein. In some implementations, some or all of the layout information can be imported as a collection or sequence of mappings produced by a separate layout module 160, which can be implemented, for example, in a library design program such as the Library Studio® software available from Symyx Technologies, Inc., of Santa Clara, Calif. See also WO 00/23921 and U.S. Publication No. 2003/0149933 A1. Alternatively, some or all of the layout information can be specified directly for each library element or region by means of a layout module 150 that is integrated with process design module 160.

A temporal profile is defined for the set of experiments by defining a plurality of experiment stages, and a start condition for each of the plurality of stages (step 220). Each stage represents a period of time during the course of the set of experiments. In one implementation, the stages are represented as a numbered sequence, although preferably each stage is independent, such that individual stages may overlap. The start condition represents an event the occurrence of which will trigger the start (or the initiation of a counter until the start) of an operation associated with the relevant stage. Thus, for example, a user may define a start condition corresponding to a start time (e.g., Time=1000”), representing the time (determined, e.g., by the system clock) at which an operation associated with a given stage will be started. Alternatively, or in addition, start conditions can be defined based on other stages (e.g., “Stage 1=complete”, representing the start or completion of another stage), process data (e.g., “Pressure>100”, representing the value of experimental parameters measured or calculated during the course of the experiments, or user input during the course of the experiments (e.g., “User=OK”). In some implementations, process design module 160 can be configured to provide for start conditions based on compound events, which comprise a combination of logic (e.g., AND, OR, NOT) and two or more basic event types (e.g., the time-, stage-, process data-, and user input-based events just described). Thus, for example, a reaction quench stage can be conditioned on a compound event corresponding to an elapsed time of more than 10,000 seconds and a pressure below 100 psi (“Time>10000 sec AND Pressure<100 psi”). Likewise, a quench stage can be conditioned to quench in the middle of the night (when time exceeds 10,000 seconds, or when integrated pressure exceeds 100 units (“Time>10000 sec OR Integrated Pressure>100 psi”). Indeed, compound events can be constructed from more than two events, to provide for even more complex control (“(Time>10000 sec AND Pressure>100 psi) OR (Time>50000)”).

In one implementation, each stage has an associated start time, which may be defined directly (i.e., as a start condition, as described above) or indirectly (e.g., based on an offset from a start condition, as described in more detail below), and an end time, which may also be defined directly or indirectly. Optionally, process design module 160 can be configured to provide for a means to mark a stage as completed, or to trigger the start condition for a stage. The former allows a user to indicate that a stage should be ended at any point during execution of the stage—for example, to force the reactor system to move to the next stage in a process (e.g., when the system is taking too long or an unexpected event has occurred). The latter can be advantageous when, for example, a stage is linked to a process parameter that is not being met, but the user desires the stage to execute anyway. Optionally, each stage can also have an associated number of steps, representing a number of discrete subunits in which a component associated with the stage is to be applied.

For each component and each associated region (as determined by the layout information obtained in step 210), method 200 then associates each component with one or more of the experiment stages (step 230). More specifically, each component associated with a given region according to the layout information can be associated with one or more of the experiment stages to indicate that the particular component in question is to be applied to the corresponding region in the context of operations performed during the associated experiment stage or stages. Optionally, step 230 can associate components with stages by apportioning the amount of a component associated with a given region among multiple experiment stages, where the portion assigning to a given stage can be represented, e.g., as an absolute amount to be associated with the stage or as a percentage of the total amount associated with the region. Typically, the user will associate the entire amount of each chemical component with one or more of the stages for each region, although in some cases it may be desirable to use more or less than the amount specified in the layout information. Thus, for example, for some chemistries it may be necessary to add one or more chemical reagents in semicontinuous fashion in order create a product with a homogeneous composition, such as copolymerization reactions involving two or more monomers having significantly different reactivity. In this case, a first fraction of the mapped monomer (e.g., 10%) can be added in an initial reactor charge, and the remaining 90% added slowly over the course of the reaction (e.g., 9 steps over the next 90 minutes). To ensure that the same product composition is being generated throughout the reaction is constant, the product generated from a reaction that was allowed to go to completion must be compared with products(s) generated from reactions stopped early. Thus, for example, three reactions can be designed with the same total composition of reagents, with the first reaction defined (as above) so that 10% of the monomer is added in the initial reactor charge and 90% is added in 9 steps over 90 minutes before the reaction is quenched. In the second reaction, 10% of the monomer can be added in the intial reactor charge, and 50% added thereafter in 5 steps over 50 minutes (such that only 50% of the total mapped monomer is defined and used). Similarly, in the third reaction 10% of the monomer is added in the initial reactor charge and just 20% is added in 2 steps over 20 minutes (such that only 30% of the total mapped monomer is defined and used). Using this design will provide products collected from the 30%, 50% and 100% positions along the reaction profile, making it possible to determine whether the products are formed homogeneously in this process. In this way a variety of processes can be tested in order to rapidly determine the best process for forming homogeneous products.

The association of components with experiment stages can be represented as a series of component profiles that describe how the components are to be applied over time to the regions of the library array. These component profiles thus represent processes that will be performed at the various regions over the course of the set of experiments, each process including one or more operations that will be performed with respect to the corresponding component and region. The processes can include operations such as deposition or dispensing of amounts of particular chemical entities, heating, cooling, stirring, pressurization, data acquisition (whether to collect data in a given stage and at what rate), and the like. More generally, the processes can be used to express any experimental parameters to the reactor system: for heating, the process can set a temperature; for cooling, the process can turn a fan on or off; for integrated pressure, the process can indicate whether or not to collect integrated pressure data, and at what rate. In general, the performance of each operation is determined by the start condition and, where applicable, the start time, end time, and/or number of steps associated with the relevant stage. In some implementations, process design module 160 automatically recognizes the type of operation that will be associated with a given stage based on the type of component associated with that stage—for example, dispense or deposition operations for components representing chemical entities, heating or cooling operations for components representing temperature, pressurization operations for components representing pressure, and the like. Alternatively, process design module can be configured to permit (or require) the user to specify an operation for one or more of the experiment stages—for example, when component amounts are associated with the stage.

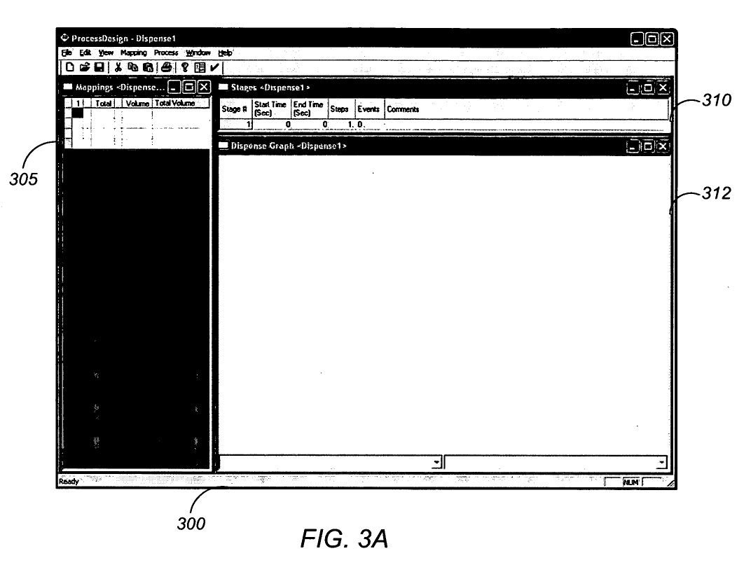

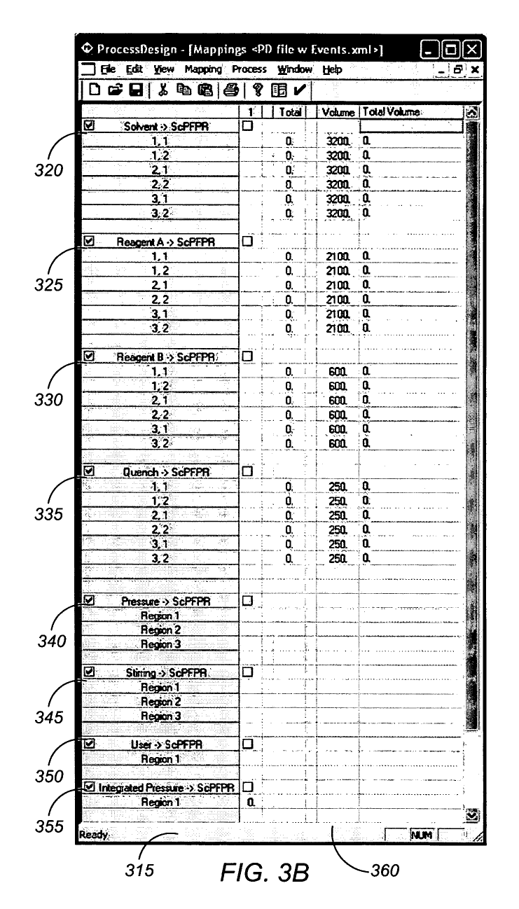

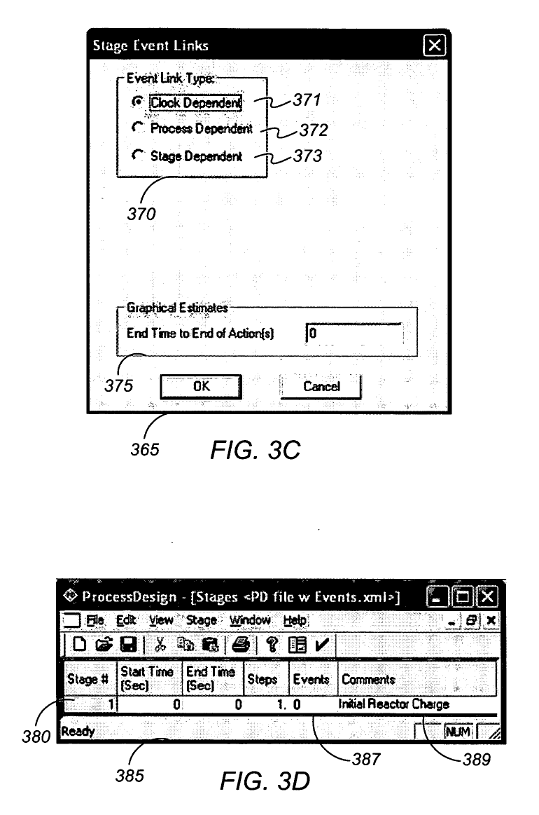

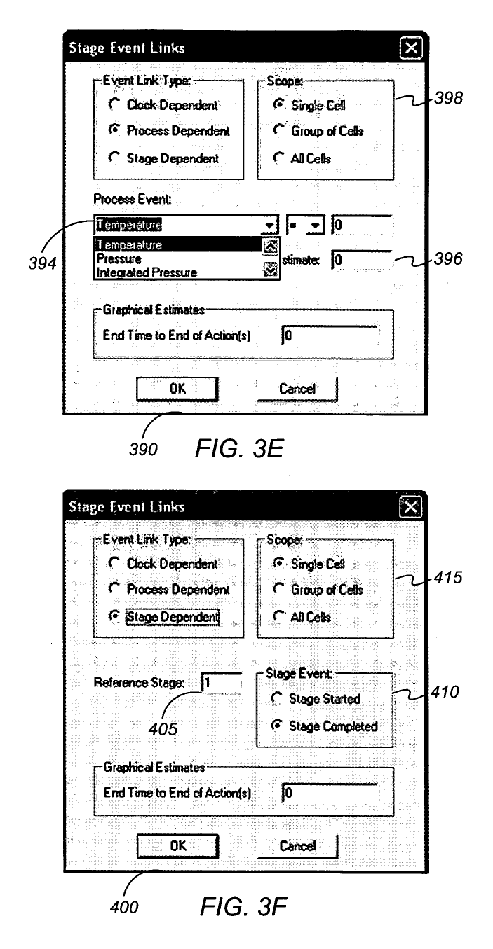

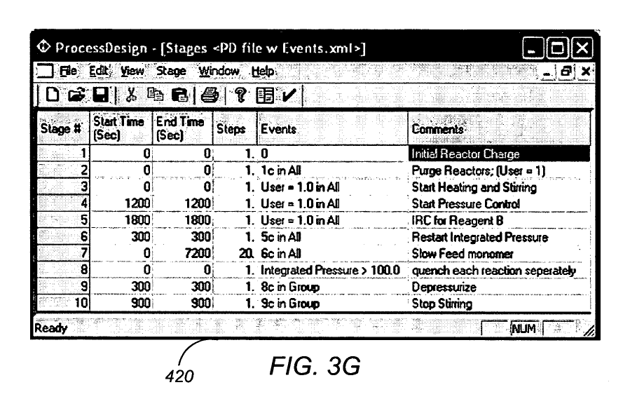

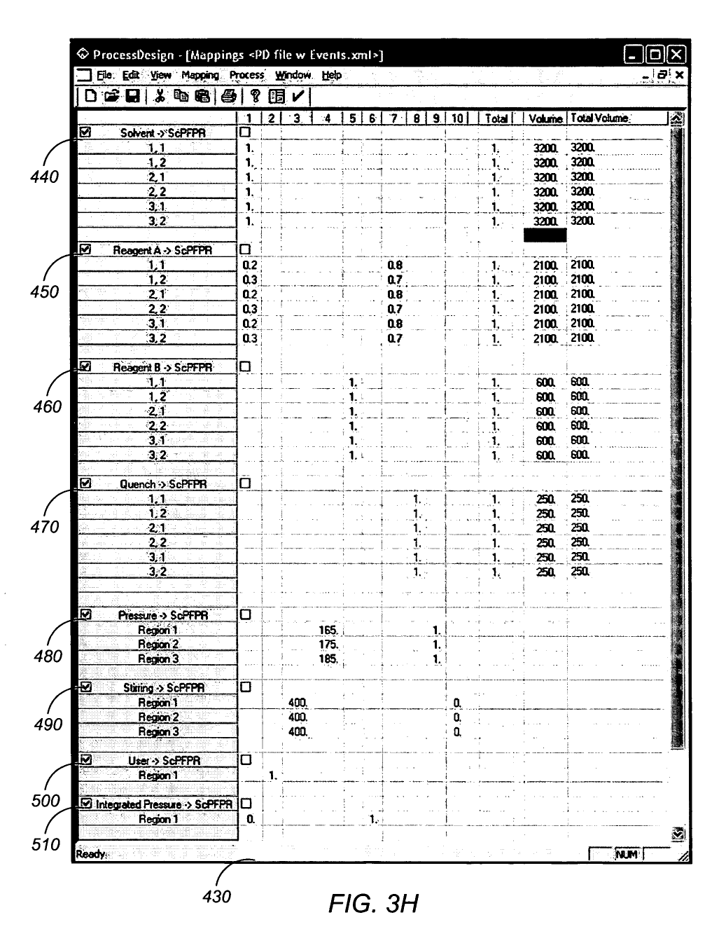

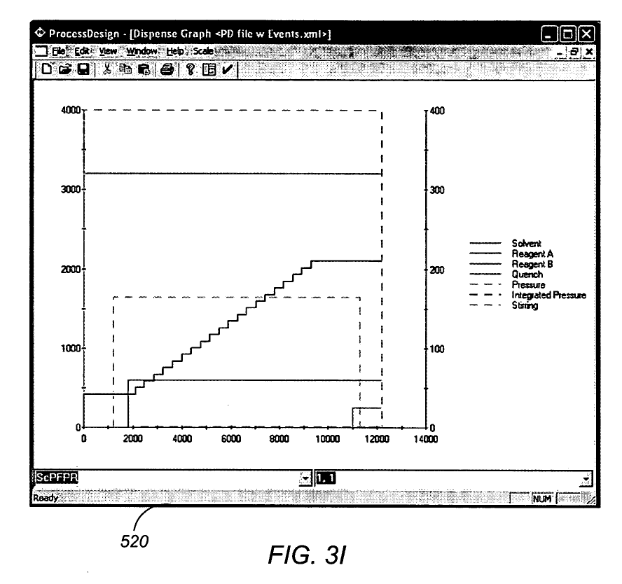

The layout information, the experiment stages, and the corresponding associations define (or can be used to generate) a process design that describes the components, experiment stages, and process operations reflected in the component profiles. In one implementation, the library design can be implemented as a Design Object having a collection of one or more component objects, a collection of stage objects, and a collection of process objects, as will be described in more detail below. A representation of the process design can be presented to the user (e.g., over display monitor 195) (step 240). For example, system 100 can display one or more of the component profiles as a graph 520 as shown in FIG. 3I. To facilitate the design process, process design module 160 preferably also displays a representation of the developing design in an array-, matrix-, or spreadsheet-based format, in which individual and/or groups of library elements are represented as cells in an array, matrix or spreadsheet, as will be illustrated in more detail below.

Data representing the component profiles can also be provided to a process control module 170 for automated execution using external devices 180. In one implementation, process design module 160 represents the component profiles as a collection of objects corresponding to the various components, stages and operations defined in method 200. This object collection can be implemented as an XML document, as will be described in more detail below, and can be provided to process control module 170, which can be configured to incorporate the component profile data into instructions in a format suitable for controlling the relevant external devices 180. Suitable process control modules 170 can be implemented, for example, in the Impressionist® and Epoch® process control software, available from Symyx Technologies, Inc., of Santa Clara, Calif. See also U.S. Pat. No. 6,507,945 and WO 01/79949, both of which are incorporated by reference herein. Optionally, the process design and/or instructions can be persisted in a laboratory data management system as described in U.S. Pat. No. 6,658,429, which is incorporated by reference herein.

As noted above, the layout information associating components and regions can be provided as a set of maps that describe how the components are to be applied to the elements of the library array. Maps can be defined to apply a single component to a single element of a library array, one component to multiple library array elements or multiple components to multiple library array elements (e.g., mapping materials located at a set of locations in a parent library to elements of a library array representing a daughter library). In one implementation, a typical map identifies a component to be applied, a set of one or more amounts of the component to be applied (where appropriate), and a set or “footprint” of library elements to which those amounts will be applied, where the amount of a given component to be applied across the library elements in the “footprint” can be constant or varying (e.g., according to a mathematical relationship such as a gradient or system of equations, as described in WO 00/23921).

As used in this specification, “apply” and “application” include depositing or dispensing an amount or amounts of a chemical entity at one or more library elements, as well as exposing the contents of one or more library elements to a particular amount (quantity) of a process parameter, such as temperature, pressure, stirring, or the like. In some implementations, “applying” can also include removing an amount or amounts of a chemical entity or process parameter from one or more library elements, such that in some implementations maps can define a decrease in quantity of a process parameter to which the contents of a library element are exposed, or the removal of a chemical from a set of elements—for example, evaporation or filtration to remove solvent, filtration of precipitate, and the like. Additionally, “applying” can in some cases include other reactor parameters, such as data acquisition modes (e.g., an integrated pressure parameter can be “applied” by turning “on” (or “off”) the acquisition of integrated pressure data in one or more reactor wells) or other operational parameters having different states (whether continuous or discrete) that can be set by specifying values for the parameter. In some implementations, the maps can be ordered to define a mapping sequence, which can take the form, e.g., of an ordered list of maps. Optionally, in such implementations process design module 160 can be configured to automatically define a default set of experiment stages based, e.g., on the number of mappings in the sequence, and to assign each component to one of the default set of experiment stages (for each region with which the component is associated), based on the order of the corresponding maps in the mapping sequence. The user can then define additional experiment stages and/or apportion the amounts of the various components among different stages as described above and in more detail below. Optionally, process design module 160 can be configured to permit the association of components—and particularly those components that represent chemical entities—with physical sources or locations from which the corresponding chemical entity can be obtained. Thus, for example, liquid components can be associated with sources that represent vials (or designated vial locations) on a work surface or feed lines connected to a liquid-handling robot. These associations can be passed to process control module 170 in order to simplify the process of translating the process design into instructions usable to control external devices 180.

It should be noted that the geometry of the library array (shape, number of elements, number of rows and columns, etc.) can be determined in or derived from the layout information imported from layout module 150, and/or it can be manually provided (or modified) in process design module 160—for example, by user selection of a predefined library configuration from a pull-down list, in response to which process design module 160 displays an array having a geometry associated with that configuration. As noted above, the array geometry may reflect the physical arrangement of actual reactor and/or robotics hardware to be used in the experiments, or it may represent the library at a more conceptual level (and be mapped onto actual hardware at a later time, such as by process control module 170). The user can define groups of library elements (e.g., elements 1-8=region 1), which may be independent of the actual geometry (e.g., rows and columns) of the array, and stage start conditions can be made to depend upon the occurrence of the specified event for each element individually, for groups of elements, or for the library as a whole. The groups may reflect actual constraints of the hardware to be used in the experiments, but they may also be defined more abstractly to provide for a higher level of control of process variation across the library array.

A simple illustrative example will now be described, in which chemical reagents A, B and C are to be reacted in varying ratios in the wells of an eight-well reactor. Process design module 160 receives from library layout module 150 a set of mappings that associate varying amounts of components A, B and C with each of the wells of an eight-well reactor. In the reaction being studied, a portion of the total amount of each of reagents A and B are initially mixed, with the remaining amounts of reagents A and B to be added stepwise over a two-hour period, with reagent C being added at that end of that period. To implement this process, the user creates a set of four stages, each of which has an associated start time, end time and number of step, as follows: Stage 1—start time 0, end time 0 (where a delta of zero means that the operation will be performed immediately), 1 step; Stage 2—start time 0.5 hrs, end time 2.5 hours, 20 steps; Stage 3—start time 0.5 hrs, end time 2.5 hrs, 100 steps; and Stage 4—start time 3 hrs, end time 3 hrs, 1 step. Then, for each mapping volume (each well of each mapping, independently) the user carve the volume into multiple fractions and associates each fraction with a corresponding stage. Thus, if the user desired to define a process for well number 1 of the reactor in which 20% of reagent A and 50% of reagent B are introduced at the beginning of the process, with the remaining reagent A was added in 20 evenly spaced increments and the remaining reagent B was added in 100 evenly spaced increments over the next 2 hours, with all of reagent C to be added at 2.5 hours, he might define the following stage associations: reagent A—stage 1: 20%; stage 2: 80%; reagent B—stage 1: 50%; stage 3: 50%); reagent C—stage 4: 100%. The mapped volumes associated with the other cells of the library can then be defined using the same stages and/or additional stages. Process parameters such as temperature, pressure, stirring can be similarly defined.

In the preceding example, each of the stages has a start condition based on the time elapsed during the reaction process. As noted above, process design module 160 can be implemented to provide for a variety of different event-based start conditions, such as clock events, stage events, process data events, and user events. One such implementation will now be described in more detail.

In this implementation, the start condition for each stage is defined based on an event type specified for the stage. For each stage defined at step 220 of method 200, process design module 160 specifies an associated event type, which can be specified, for example, based on a selection by the user from a set of predetermined event types—for example, event types corresponding to the clock events, stage events, process data events, and user events mentioned above. The first of these event types, the clock event, permits process design module 160 to specify start conditions based on time (e.g., off of the main clock) as in the example described above. The second event type, the stage event, can be used to specify a start condition at some time past the start or completion of the operations associated with another stage. Thus, in the example above, Stage 2 could be implemented with a start time of 5 minutes, an end time of 2 hrs and 5 min, in 20 steps, with a stage event linking the stage to the completion of stage 1. In this way, the operations of Stage 2 would begin 5 minutes after the completion of the operations of Stage 1.

The third event type, the process data event, lets process design module 160 specify start conditions based on data values measured or calculated during the course of the process. Thus, for example, if the reactor used in the example discussed above is equipped with a probe that is capable of monitoring some aspect of the reaction, such as the amount of reagent A, then a process data event can be used to specify a start condition based on that parameter reaching a certain value. So in the above example, assuming a probe monitoring the amount of reagent A in the reaction, Stage 4 could be implemented with a start time of 0, and end time of 0, in 1 step, with a process data event link to the probe for reagent A specifying the addition of reagent C when reagent A is 98% consumed. Similarly, a process data event could be used in an exothermic reaction monitored with a thermocouple, to specify a start condition for Stage 4 when the temperature drops below a certain level.

The final event type in this implementation, the user event (which can be implemented as a subclass of the process data event), enables process design module to permit the user to trigger a start condition based on manual input (e.g., to specify a timeout that is necessary for some reason). Thus, for example, if the reaction requires two different reaction gasses, but the switching of gas cylinders attached to the reactor is not automated, the user could attach a cylinder of the first gas to the reactor and start the reaction process, and, when the use of the first gas is completed, manually attach a cylinder of the second gas and trigger the start condition of a subsequent stage in the design (such as the addition of other liquid chemicals) by submitting specified input, such that the subsequent stage will only start when the user specifies that the previous manual step is complete.

Stages having a process data event-based start condition can be used to provide automated real-time monitoring and feedback control of processes across the library array during the course of the set of experiments. Thus, a process data event can be used to trigger a subsequent operation based on the detection of the end of a reaction. For example, the process may include reactions that must be quenched at a specific point in order to permit comparison of the various reactions to one another, as when data from a set of reactions can only be meaningfully compared if the reactions are all stopped at about the same conversion level. If the reactor hardware includes a device that is capable of monitoring the reaction status on a real-time basis, such as a measure of the amount or concentration of one or more components in the reaction or the amount of one or more component that has been consumed by the reaction as noted above, then the design can include a predetermined level such that when that level is reached in a given cell, an operation is triggered that will stop the reaction in that cell. Thus, for example, if the reaction involves a gaseous reagent and the pressure is being kept at a constant level, and the amount of gas (the integrated pressure) can be calculated and the process design can define an amount of the gaseous reagent consumed (the IP value) at which each reaction will be quenched. Likewise, in a design intended to examine the variation in the product(s) of a reaction as a function of the conversion, the process design can provide for varying the IP value at quench for each library element. Other in situ monitoring devices can be used to provide analogous types of control.

Process data events can also be used to determine feed profiles for chemical reagents. In some reactions, one or more chemical reagents must be added over the course of the reaction. Although this can be done by defining a specific time after the start of the experiment at which each addition, to each well, will occur, if the reactor hardware includes an in situ monitor that is capable of monitoring the progress of the reaction, the process design can include predetermined values of the monitored parameter at which the reagent additions will occur. In one such example, involving the copolymerization of two monomers, one of which is a gas and the other a liquid, and both are fed in semicontinuous fashion into the reaction wells, the gaseous reagent is kept at a constant concentration by keeping the pressure constant, and the amount of gas consumed (the integrated pressure—IP) is monitored for each reaction in the array. The process design can predefine the IP interval, which is proportional to the amount of the gaseous reagent consumed, at which the liquid reagent will be added. Thus, for example, an IP interval of 10 psi can be defined in order to ensure that all reactions consume 100 psi of gaseous reagent, and the liquid reagent is added in 10 steps evenly over the course of the reaction.

In still another class of feedback control, a reaction requires that one component be maintained in a specified concentration range. In this case, a probe capable of measuring the amount of that reagent present in the reaction, such as an optical Raman or IR probe that can be calibrated for the specific reagent (to correlate signal intensity to concentration), can be used in the reactor array. The process design can predefine a maximum and minimum concentration value for the reagent, and an incremental dispense volume by which the reagent will be added. As the reactions proceed, the optical probes monitor the real-time concentration of the reagent in each library element and reagent is added in sufficient amounts to maintain the concentration in the desired range. Thus, if at any given time during the reaction the concentration is observed to fall below the lower limit, reagent is added to the reaction well in an amount intended to raise the concentration into the desired range; by contrast, if the concentration is found to be above the lower limit, no addition will occur. By monitoring the change in concentration as a function of the addition profile, it will be possible to determine whether the incremental addition volume used was appropriate (if the concentration change after addition is too small or too large compared to the desired concentration range). This type of process feedback control can be useful to accelerate the discovery of novel materials or processes, in making discoveries that are most easily scaled-up if certain limitations of scale are known, and in optimizing processes for scale-up by providing a better understanding of the correlation between the product and the specific process used.

In implementations providing in situ monitoring and feedback control, process design module 160 (and process control module 170) can be configured to provide for monitoring and feedback based on the whole reactor or some subset thereof, such that a start condition for a stage or process data event type can be triggered when an individual well (i.e., library element) satisfies the start condition, or when a group of wells (or region), which may correspond to some or even all of the wells in the reactor satisfies the condition. Thus, for example, in the above example in which a stage is triggered when a probe shows that a reagent is 98% consumed, it might be preferable to start the new stage on a well-by-well basis. That is, the reagent concentration is monitored in each well, and when an individual well shows 98% completion, the operation(s) of the new stage will commence in that well, independent of what is happening on other wells.

In other cases, it may not be possible, desirable, or necessary to monitor and/or control the reaction on a well-by-well basis—for example, the reactor may be configured to provide temperature control for eight-well reactor blocks of a multi-block reactor, but not independently for each well in each block temperature. In such cases, the process design can specify that a given stage will be triggered only when all of the wells in a block satisfy the start condition—e.g., when all wells in a particular block reach a temperature set-point specified by a process data event associated with the stage.

The user's interaction with system 100 in one such implementation will now be described in the context of FIGS. 3A-3I, which illustrate a user interface to process design module 160. The user begins the process design procedure by launching process control module 160. In response, process control module 160 displays an interface 300 as shown in FIG. 3A, which includes a Mappings pane 305, a Stages pane 310 and a Dispense Graph pane 312, all of which are initially empty. Next, the user populates Mappings pane 305 with data describing the component layout to be used in the design—for example, by manually entering data into the cells of Mapping pane 305, or by importing layout information generated by another source, such as library layout module 150 (which can be done, for example, by selecting “File->Import” in the menus shown in FIG. 3A).

Upon importation of appropriate layout information, process design module 160 populates Mappings pane 315 as shown in FIG. 3B (where Stages pane 310 and Dispense Graph pane 315 are minimized for clarity). As shown in FIG. 3B, Mappings pane 315 includes an entry for each mapping defined in the imported layout information, including a Solvent mapping 320 for a component representing solvent, a Reagent A mapping 325 for a component representing chemical entity A, a Reagent B mapping 330 for a component representing chemical entity B, a Quench mapping 335 for a component representing a quenching agent, a Pressure mapping 340 for a component representing pressure, and a Stirring mapping 345 for a component representing stirring. As shown, Mappings pane 315 also includes a User mapping 350, which represents one or more user events that will be relied upon in the process design as discussed in more detail below, and an Integrated Pressure mapping 355, which will be used to control the monitoring of an integrated pressure parameter during the course of the set of experiments. The entry for each mapping includes a row corresponding to each region associated with the corresponding component—library elements 1,1 through 3,2 for each component representing a chemical entity, Regions 1 through 3 for each of pressure and stirring (corresponding to three two-well reactor blocks for which pressure and stirring can be controlled), and Region 1 for User mapping 350 and Integrated Pressure mapping 355 (indicating that these mappings apply only to a single group of elements—here, the entire reactor, as will be discussed in more detail below). Volume column 360 identifies the total volume of each chemical component that will be deposited at each library element; at this point in the design workflow, columns corresponding to Total and Total Volume associated with each region are empty. The user can enter or change values by selecting the appropriate cell and typing a desired value. Existing mappings can be deleted and new mappings added by making the appropriate selection in the Mapping menu.

The user begins to define the experiment stages by activating the Stages pane 310 and selecting Stage->Add in the Stage menu (see, e.g., FIG. 3D), which causes process design module 160 to display a Stage Event Links dialog 365, as shown in FIG. 3C. In dialog 360, the user is prompted to select an event type in pane 370—here, selecting between Clock Dependent type 371, Process Dependent type 372 and Stage Dependent type 373. In the example shown in FIG. 3C, the user has selected the Clock Dependent type 371, thus specifying a stage having a clock event type start condition, and is further prompted to provide an estimate of the time to the end of the corresponding operation in field 375, which is used to construct a graphical representation of the process (specifically, to determine how to represent the start time for any subsequent stage that is dependent upon completion of the stage in Dispense Graph 520 illustrated in FIG. 31). When the user selects the OK button, process design module 160 creates a first stage having a clock event type. The new stage is represented as an entry (Stage 1) 380 in Stages pane 385, where a 0 in Events column 387 identifies the stage as having a clock event type start condition and the user has supplied Comments 389 identifying the stage as an initial reactor charge.

The user defines the remaining stages in a similar fashion, using the Stage Event Links dialog to define start conditions (Stage Event Links) for each stage. To define a process data event, the user selects Process Dependent type 372 in pane 370 (FIG. 3C), which causes process design module 160 to modify the Stage Event Links dialog as shown in FIG. 3E. Thus, Stage Event Links dialog 390 prompts the user to identify the process parameter upon which the process data event will depend—here, by selecting from the parameters Temperature, Pressure and Integrated Pressure (which may be predefined in the imported layout information, or defined by adding components in Mappings pane 305), defining an appropriate dependency (e.g., greater than, less than, or equal to a specified target value) in fields 394, and providing a time estimate for when the specified threshold will be reached in field 396. The dialog also includes a Scope pane 398, in which the user can specify that the process data event applies to a single well, a group of wells, or all wells in the library array.

Likewise, to define a stage event, the user selects Stage Dependent type 373 in pane 370 (FIG. 3C), which causes process design module 160 to modify the Stage Event Links dialog as shown in FIG. 3F. Thus, Stage Event Links dialog 400 prompts the user to identify the stage upon which the stage event will depend in Reference Stage field 405, and to specify a stage dependency in field 410, which in this example determines whether the current stage will be triggered by the start or completion of the specified reference stage. Again, the user can specify whether the stage event applies to a single well, a group of wells, or all wells in the library array using Scope pane 415.

As each stage is defined, a corresponding entry is added to Stages pane 310. The complete list of stages for the present example is shown in FIG. 3G, where Stages pane 420 identifies 10 stages, including one stage having a clock event-based start condition (Stage 1), followed by a stage having a start condition based on a stage event (Stage 2), which represents a reactor purge to be performed upon completion of stage 1 in all wells (represented by the Events column entry “1c in All”). A series of three stages with start conditions based on user events represent the start of heating and stirring (Stage 3), the start of pressure control (Stage 4) and the initial reactor charge for reagent B (Stage 4), all of which will be performed in response to user input at the completion of the reactor purge of Stage 2 (represented by Events column entries “User=1.0 in All”, with Stage 3 to start immediately upon receipt of the user input, Stage 4 1200 seconds thereafter, and Stage 5 after another 600 seconds). In Stage 6 (a stage event-dependent stage), measurement of integrated pressure is started in all wells 300 seconds after completion of Stage 5 for all wells. Stage 7 represents the introduction of monomer into all wells, to be performed in 20 steps over 7200 seconds beginning immediately after the completion of Stage 6 in all wells. Stage 8 (a process data event-dependent stage) quenches the reaction in each well individually, when the integrated pressure measured for the well exceeds 100.0. Stage 9 depressurizes the reactor 300 seconds after completion of the quench on a per-group basis (“8c in Group), and Stage 10 stops stirring after completion of depressurization, also on a per-group basis.

The association of components with these stages is illustrated by Mappings pane 430 in FIG. 3H. Here, Solvent mapping 440 associates the full amount of solvent (3200 μl) with Stage 1 for each well, indicating that this amount will be added to each well during the initial reactor charge operation in that stage. Reagent A mapping 450 associates and a specified (varying) percentage of the total amount of Reagent A with Stage 1 for each well, indicating that these amounts will also be added to each well during the initial reactor charge, and associates the remaining percentage of Reagent A with Stage 7 for each well, indicating that the remainder of this reagent will be added over 20 steps during the slow feed operation in that stage. Reagent B mapping 460 associates the full amount of Reagent B (600 μl) with Stage 5—the initial reactor charge for Reagent B, as noted above—for each well, indicating that the full amount of this reagent will be added to each well 1800 seconds after the user-specified completion of the reactor purge (Stage 2). Quench mapping 470 likewise associates the full amount of the quenching agent (250 μl) with Stage 8, which indicates that that amount of the quenching agent will added to each well individually in that stage, when the observed integrated pressure for the well exceeds 100.0.

Pressure mapping 480 associates the pressure component (representing pressurization of three two-well reactor blocks) with Stage 4 for each of Regions 1, 2 and 3 (which correspond to the three reactor blocks) in varying amounts, indicating that a first block (Region 1) will be pressurized to 165 psi, a second block (Region 2) to 175 psi, and a third block (Region 3) to 185 psi during that stage. Pressure mapping 480 further associates the pressure component with stage 9, indicating that the pressure in each block will be reduced to atmospheric pressure in that depressurization stage. Similarly, Stirring mapping 490 associates the stirring component with Stage 3, indicating that stirring will be initiated at 400 Hz during that stage, and with Stage 10, indicating that stirring will be stopped (i.e., set to 0 Hz) during that stage. Finally, User mapping 500 and Integrated Pressure mapping 510 are associated with Stages 2 and 6, respectively, for the entire reactor (Region 1), indicating that process control module 170 will prompt the user for input in Stage 2 and initiate measurement of integrated pressure in Stage 6.

Based on the components, stages, and associations, process design module 160 generates an XML document representing the process design. In this example, the document includes a collection of Stage elements representing the defined stages, which includes the following:

```
- <Stages>
  - <Stage>
    <StartTime>0.</StartTime>
    <EndTime>0.</EndTime>
    <Steps>1</Steps>
    <ActionEndTimeEstimate>0.</ActionEndTimeEstimate>
    <Comment>Initial Reactor Charge</Comment>
  </Stage>
  - <Stage>
    <StartTime>0.</StartTime>
    <EndTime>0.</EndTime>
    <Steps>1</Steps>
    <ActionEndTimeEstimate>0.</ActionEndTimeEstimate>
  - <StageDependent>
        <ReferenceStage>0</ReferenceStage>
        <StageTriggerEvent>Stage Completed</StageTriggerEvent>
        <StageScope>All Cells</StageScope>
    </StageDependent>
    <Comment>Purge Reactors; (User = 1)</Comment>
  </Stage>
  - <Stage>
    <StartTime>0.</StartTime>
    <EndTime>0.</EndTime>
    <Steps>1</Steps>
    <ActionEndTimeEstimate>0.</ActionEndTimeEstimate>
  - <ProcessDependent>
        <ProcessEvent>User</ProcessEvent>
        <ProcessComparator>=</ProcessComparator>
        <ProcessValue>1.</ProcessValue>
        <ProcessTimeEstimate>0.</ProcessTimeEstimate>
        <ProcessScope>All Cells</ProcessScope>
    </ProcessDependent>
    <Comment>Start Heating and Stirring</Comment>
  </Stage>
  ...
  - <Stage>
    <StartTime>0.</StartTime>
    <EndTime>0.</EndTime>
    <Steps>1</Steps>
    <ActionEndTimeEstimate>5.</ActionEndTimeEstimate>
  - <ProcessDependent>
        <ProcessEvent>Integrated Pressure</ProcessEvent>
        <ProcessComparator>></ProcessComparator>
        <ProcessValue>100.</ProcessValue>
        <ProcessTimeEstimate>11000.</ProcessTimeEstimate>
        <ProcessScope>Single Cell</ProcessScope>
    </ProcessDependent>
    <Comment>quench each reaction seperately</Comment>
  </Stage>
  ...
  </Stages>
```

As is apparent from this XML listing, these elements correspond to stages 1, 2, 3 and 8, as shown in FIG. 3G and discussed above. The first Stage node, which represents the Initial Reactor charge (Stage 1), has a start and end time of 0, as determined using the main clock, with a single step specified. When this stage is executed, the reactor will dispense all of the material in the Initial Reactor Charge (i.e., all component amounts associated with Stage 1) as fast as possible. It should be noted that the specification of a particular start time, end time and number of steps in the process design may not guarantee that the component in question will actually be applied according to those values, since the actual application of the design is subject to the limitations of the physical hardware upon which the process is performed. Thus, if the design specifies a stage having a start time of 0, an end time of 100, with 100 steps, the reactor may not be able to keep up with the timing specified in the design. In such a case, the reactor might go to each position and determine how much of the component to apply at that location, but when the elapsed time exceeds 100 (sec), the reactor might simply dispense the entire volume to the cell.

The second stage node, which represents the reactor purge (Stage 2), specifies that the stage begins when another stage (here, Stage 1) completes for all wells. The next Stage node, which represents the Start Heating and Stirring stage (Stage 3), is an example of a User event. When the process “User” has a value equal to 1 for all wells, this stage will begin. The final Stage node, which represents the quench stage (Stage 8), shows how one stage can start at different times for different wells. For this stage, the grouping is “Single Cell” which means each well is in its own group, meaning that the stage will begin for a given well based on a check of integrated pressure for just that well.

The document also includes a collection of Component elements that represent the chemical entities used in the design, as follows:

```
- <Components>
  - <Component>
    <Name>Solvent</Name>
    <FeedLine>−1.</FeedLine>
  </Component>
  - <Component>
    <Name>Reagent A</Name>
    <FeedLine>−1.</FeedLine>
  </Component>
  - <Component>
    <Name>Reagent B</Name>
    <FeedLine>−1.</FeedLine>
  </Component>
  - <Component>
    <Name>Quench</Name>
    <FeedLine>−1.</FeedLine>
  </Component>
  </Components>
```

Here, each of the four components is associated with a “FeedLine” that can be used by process control module 170 to identify a physical location from which each component can be obtained. Here, a FeedLine value of “−1” indicates that no location has been selected, and the user must specify the location at experiment time. In this implementation, process components (e.g., pressure, stirring, etc.) are treated as a separate element type than chemical components, as will be shown below.

Next, the process design document includes a collection of Dispense elements that represent the operations to be performed in order to apply the chemical components to the various library elements, as shown in the following excerpt:

```
- <Dispenses>
...
  - <Dispense>
  <Source>Reagent A</Source>
  <Destination>ScPFPR</Destination>
  <DestinationRows>3</DestinationRows>
  <DestinationColumns>2</DestinationColumns>
  <MappingDisplayType>0</MappingDisplayType>
  - <Cells>
  - <Cell>
      <Row>0</Row>
      <Column>0</Column>
      <DispenseVolume>2100.</DispenseVolume>
    -  <DispenseFractions>
        <DispenseFraction>0.2</DispenseFraction>
        <DispenseFraction>NULL</DispenseFraction>
        <DispenseFraction>NULL</DispenseFraction>
        <DispenseFraction>NULL</DispenseFraction>
        <DispenseFraction>NULL</DispenseFraction>
        <DispenseFraction>NULL</DispenseFraction>
        <DispenseFraction>0.8</DispenseFraction>
        <DispenseFraction>NULL</DispenseFraction>
        <DispenseFraction>NULL</DispenseFraction>
        <DispenseFraction>NULL</DispenseFraction>
      </DispenseFractions>
  -  <Volumes>
        <Volume>420.<Volume>
        <Volume>0.</Volume>
        <Volume>0.</Volume>
        <Volume>0.</Volume>
        <Volume>0.</Volume>
        <Volume>0.</Volume>
        <Volume>1680.</Volume>
        <Volume>0.</Volume>
        <Volume>0.</Volume>
        <Volume>0.</Volume>
      </Volumes>
    </Cell>
  ...
  </Cells>
</Dispense>
  ...
</Dispenses>
```

As can be seen from this listing, each Dispense operation is broken up into a set of Cell sub-elements, each of which contains a collection of DispenseFraction elements and a collection of Volume elements, with one DispenseFraction and one Volume element corresponding to each stage in the process design. Thus, in the particular example illustrated in the listing—which shows the application of Reagent A to library element 1,1—420 units of Reagent A (or 20% of the total volume to be added) is to be added in Stage 1, while 1680 units (or 80%) is to be added in Stage 7.

Finally, in this implementation the XML document also includes a collection of Process elements that represent the process components to be applied in the design, as illustrated in the following listing, which represents the Pressure component:

```
- <Processes>
  - <Process>
    <ProcessType>Pressure</ProcessType>
    <Destination>ScPFPR</Destination>
  <DestinationRows>3</DestinationRows>
  <DestinationColumns>2</DestinationColumns>
  - <Regions>
  - <Region>
    -  <Settings>
        <Setting>NULL</Setting>
        <Setting>NULL</Setting>
        <Setting>NULL</Setting>
        <Setting>165.</Setting>
        <Setting>NULL</Setting>
        <Setting>NULL</Setting>
        <Setting>NULL</Setting>
        <Setting>NULL</Setting>
        <Setting>1.</Setting>
        <Setting>NULL</Setting>
      </Settings>
    </Region>
  - <Region>
    -  <Settings>
        <Setting>NULL</Setting>
        <Setting>NULL</Setting>
        <Setting>NULL</Setting>
        <Setting>175.</Setting>
        <Setting>NULL</Setting>
        <Setting>NULL</Setting>
        <Setting>NULL</Setting>
        <Setting>NULL</Setting>
        <Setting>1.</Setting>
        <Setting>NULL</Setting>
      </Settings>
    </Region>
  - <Region>
    -  <Settings>
        <Setting>NULL</Setting>
        <Setting>NULL</Setting>
        <Setting>NULL</Setting>
        <Setting>185.</Setting>
        <Setting>NULL</Setting>
        <Setting>NULL</Setting>
        <Setting>NULL</Setting>
        <Setting>NULL</Setting>
        <Setting>1.</Setting>
        <Setting>NULL</Setting>
      </Settings>
    </Region>
  </Regions>
  - <RegionRows>
  - <RegionRow>
    -  <RegionColumns>
        <RegionColumn>0</RegionColumn>
        <RegionColumn>0</RegionColumn>
      </RegionColumns>
    </RegionRow>
  - <RegionRow>
    -  <RegionColumns>
        <RegionColumn>1</RegionColumn>
        <RegionColumn>1</RegionColumn>
      </RegionColumns>
    </RegionRow>
  - <RegionRow>
    -  <RegionColumns>
        <RegionColumn>2</RegionColumn>
        <RegionColumn>2</RegionColumn>
      </RegionColumns>
    </RegionRow>
  </RegionRows>
  <Locked>2</Locked>
  </Process>
...
</Processes>
```

As can be seen from this listing, in this implementation Process elements are used to contain information identifying the process component in question, the regions (or library element groupings, here represented as RegionRow elements) to which the component will be applied, and the amounts in which the component will be applied (here represented by the Region and Setting elements). Alternatively, process components could be identified using the same (or similar) Component elements as shown above for chemical components, and the application of these components to the library could be specified using elements directly analogous to the Dispense elements shown above. In such implementations, a collection of region (or RegionRow) elements describing the elements or groupings applicable to any given component could be included, e.g., as subelements of the appropriate Component element.

At any time during the design process, system 100 can display a visual representation of the developing process design on monitor 195, such as a set of component profiles illustrating the application of the various components to the regions of the library array over the course of the experiments. A Dispense Graph 520 reflecting such component profiles for well 1,1 in this example is shown in FIG. 3I.

In the example discussed above, the Mappings pane presents a linear display of component/stage associations with the relevant regions arranged as a list, such that rows represent regions and columns represent stages. In an alternative implementation (or as a user-selectable option in the above-discussed example), the interface can be configured to provide an array-based presentation, in which, for each component mapping, the Mappings pane presents a plurality of arrays corresponding to the library array. In this implementation, each array element represents a region with which the component has been associated (i.e., in the layout information), and the Mappings pane can present one such array for each stage defined for the set of experiments, such that the values associated with elements of a given array represent component amounts assigned to the corresponding region for the stage in question. To simplify the display, arrays may be collapsed or omitted for any stage that is not associated with the stage in question.

Process designs generated using the techniques described herein can be used in conjunction with process control software applications such as that described in U.S. Pat. No. 6,507,945 and WO 01/79949. In such implementations, process control module 170 uses the process design as a source of control data to be used as input (e.g., where to find chemical components, how much volume to dispense, what well in which to dispense) for material-handling procedures provided in those applications (or, for example, in software libraries provided by manufacturers of devices 180.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. The essential elements of a computer are a processor for executing instructions and a memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. Thus, for example, although the invention has been described largely in the context of the design of synthesis processes, as noted above the techniques described herein can be used to design processes for complex workflows. Thus, for example, the process design techniques of the present invention can be used to design processes that involve the use of process events that monitor screening data collected for an experiment and compare that data to specified “criteria for success” limits for the screen (such that the monitored value must be greater than or less than a specified value, or within a specified range, for the experiment to be considered a hit or lead), to determine whether that experiment or product should be moved to a second level of screening. As another example, the techniques of the present invention can be used to provide notification and tracking of the position of a certain material or library within a workflow. Thus, if three people work on a project in which one scientist performs a synthesis, another performs a primary or coarse screen, and a third performs a secondary or fine screen, a process design could include stages for each of these three steps, where a primary screening stage is linked to a user event (such that when the synthesis is complete, the responsible scientist activates the user event), and a secondary screening stage is linked to both a stage-complete event and a parameter event (as discussed above). In such an implementation, the primary screening scientist might receive an email that was automatically generated when the synthesis scientist designated the synthesis as complete, notifying the primary screening scientist that a particular library is ready for screening. Similarly, the secondary screening scientist might receive an email upon completion of the primary screening for the library, where the email might identify which elements of the library met the parameter requirement. When the secondary screening scientist then performed the secondary screening, the system might provide that only the elements identified as meeting the parameter requirement would be “available” from the database (or computer tracking system). In addition, this type of tracking using a workflow process design might allow any of these users, or another person such as a manager or collaborator, to identify the status of each library, and potentially each element of a library, at any point in the overall workflow. This scenario could also make it possible to specifically capture the workflow that was used, including the “criteria for success” applied. Thus any change over time could be readily tracked, and it would be a straightforward matter to reprocess libraries using new “criteria”. Accordingly, other embodiments are within the scope of the following claims.

What is claimed is:

1. A computer-implemented method for designing an automated or semi-automated process to be performed at one or more regions of an experiment library, the process involving the application of a plurality of components at the one or more regions, the method comprising:
associating one or more components with each of a plurality of regions of the experiment library, each of the components representing a material or process parameter to be applied at the associated regions;
defining a plurality of experiment stages, each of the plurality of experiment stages having one or more associated event types selected from a plurality of predetermined event types, the one or more event types defining a start condition for the corresponding stage;
for each of the plurality of regions of the experiment library, associating each of the associated components with one or more of the experiment stages; and
generating a plurality of component profiles representing processes to be performed at the regions of the experiment library, each component profile describing the application over time of one or more of the components associated with a corresponding region or regions according to the associated experiment stages.

2. The method of claim 1, wherein:
the plurality of predetermined event types includes a stage event specifying a start condition for the corresponding experiment stage based on another stage in the plurality of experiment stages.

3. The method claim 1, wherein:
the plurality of predetermined event types includes a process data event specifying a start condition for the corresponding experiment stage based on a value of a parameter being monitored during the process.

4. The method of claim 1, wherein:
the plurality of predetermined event types includes a user event specifying a start condition for the corresponding experiment stage based on user input during the process.

5. The method of claim 1, wherein:
the plurality of predetermined event types includes a stage event specifying a start condition for the corresponding experiment stage based on another stage in the plurality of experiment stages, a process data event specifying a start condition for the corresponding experiment stage based on a value of a parameter being monitored during the process, a user event specifying a start condition for the corresponding experiment stage based on user input during the process, and a clock event specifying a start condition for the corresponding experiment stage based on a specified time in the process.

6. The method of claim 1, wherein:
defining the experiment stages includes defining one or more experiment stages having a compound start condition defined by a plurality of the event types.

7. The method of claim 1, wherein:
associating the one or more components with the plurality of regions includes receiving a plurality of component mappings, each mapping assigning an amount or amounts of one of the components to one or more of the plurality of regions; and
associating the components with the experiment stages includes, for each of the component mappings and each of the corresponding regions, associating the corresponding component amount or amounts with one or more of the experiment stages.

8. The method of claim 1, wherein:
associating the components with the experiment stages includes, for a given region, associating a first amount of one of the components with a first stage of the plurality of experiment stages and a second amount of the component with a second stage of the plurality of experiment stages.

9. The method of claim 1, wherein:
the experiment library includes a plurality of library members, each library member representing a location at which an experiment in a set of experiments can be performed; and
one or more of the components are associated with one or more regions of the experiment library that represent groups including a plurality of the library members.

10. The method of claim 9, wherein:
defining the experiment stages includes defining one or more experiment stages having a start condition that depends on an occurrence of an event for each of the library members in one or more groups represented by one or more of the regions.

11. The method of claim 1, further comprising:
displaying a graphical representation of one or more of the component profiles to a user.

12. The method of claim 1, further comprising:
generating a process design comprising electronic data representing the components, experiment stages and processes.

13. The method of claim 1, further comprising:
executing a set of experiments by applying the components to the regions of the experiment library according to the component profiles, such that each component associated with a given region of the experiment library is applied to the given region according to the start conditions of the stages associated with the component.

14. The method of claim 13, wherein executing the set of experiments includes:
translating the process design into instructions for one or more automated devices; and
executing the set of experiments using the one or more automated devices according to the instructions.

15. The method of claim 13, wherein:
the plurality of experiment stages includes an experiment stage having a process data event type having a start condition based on a target value of a specified parameter; and
executing the set of experiments includes monitoring the specified parameter for one or more of the regions during execution of the set of experiments, and applying the component or components associated with the experiment stage according to the corresponding component profile when a monitored value of the specified parameter reaches the target value.

16. The method of claim 15, wherein:
applying the component or components includes applying the component or components associated with the experiment stage to the corresponding regions according to the corresponding component profile only when a monitored value of the specified parameter reaches the target value for all members of the experiment library.

17. The method of claim 15, wherein:
applying the component or components includes applying the component or components associated with the experiment stage to a given region according to the corresponding component profile when a monitored value of the specified parameter reaches the target value for the given region of the experiment library.

18. A computer program product, tangibly embodied on a computer readable medium, for designing an automated or semi-automated process to be performed at one or more regions of an experiment library, the process involving the application of a plurality of components at the one or more regions, the product including instructions operable to cause a programmable processor to perform operations comprising:
associating one or more components with each of a plurality of regions of the experiment library, each of the components representing a material or process parameter to be applied at the associated regions;
defining a plurality of experiment stages, each of the plurality of experiment stages having one or more associated event types selected from a plurality of predetermined event types, the one or more event types defining a start condition for the corresponding stage;
for each of the plurality of regions of the experiment library, associating each of the associated components with one or more of the experiment stages; and
generating a plurality of component profiles representing processes to be performed at the regions of the experiment library, each component profile describing the application over time of one or more of the components associated with a corresponding region or regions according to the associated experiment stages.

19. The computer program product of claim 18, wherein:
the plurality of predetermined event types includes a stage event specifying a start condition for the corresponding experiment stage based on another stage in the plurality of experiment stages.

20. The computer program product of claim 18, wherein:
the plurality of predetermined event types includes a process data event specifying a start condition for the corresponding experiment stage based on a value of a parameter being monitored during the process.

21. The computer program product of claim 18, wherein:
the plurality of predetermined event types includes a user event specifying a start condition for the corresponding experiment stage based on user input during the process.

22. The computer program product of claim 18, wherein:
the plurality of predetermined event types includes a stage event specifying a start condition for the corresponding experiment stage based on another stage in the plurality of experiment stages, a process data event specifying a start condition for the corresponding experiment stage based on a value of a parameter being monitored during the process, a user event specifying a start condition for the corresponding experiment stage based on user input during the process, and a clock event specifying a start condition for the corresponding experiment stage based on a specified time in the process.

23. The computer program product of claim 18, wherein:
defining the experiment stages includes defining one or more experiment stages having a compound start condition defined by a plurality of the event types.

24. The computer program product of claim 18, wherein:
associating the one or more components with the plurality of regions includes receiving a plurality of component mappings, each mapping assigning an amount or amounts of one of the components to one or more of the plurality of regions; and
associating the components with the experiment stages includes, for each of the component mappings and each of the corresponding regions, associating the corresponding component amount or amounts with one or more of the experiment stages.

25. The computer program product of claim 18, wherein:
associating the components with the experiment stages includes, for a given region, associating a first amount of one of the components with a first stage of the plurality of experiment stages and a second amount of the component with a second stage of the plurality of experiment stages.

26. The computer program product of claim 18, wherein:
the experiment library includes a plurality of library members, each library member representing a location at which an experiment in a set of experiments can be performed; and
one or more of the components are associated with one or more regions of the experiment library that represent groups including a plurality of the library members.

27. The computer program product of claim 26, wherein:
defining the experiment stages includes defining one or more experiment stages having a start condition that depends on an occurrence of an event for each of the library members in one or more groups represented by one or more of the regions.

28. The computer program product of claim 18, the product including instructions operable to cause a programmable processor to perform operations further comprising:
displaying a graphical representation of one or more of the component profiles to a user.

29. The computer program product of claim 18, the product including instructions operable to cause a programmable processor to perform operations further comprising:
generating a process design comprising electronic data representing the components, experiment stages and processes.

30. The computer program product of claim 18, the product including instructions operable to cause a programmable processor to perform operations further comprising:
executing a set of experiments by applying the components to the regions of the experiment library according to the component profiles, such that each component associated with a given region of the experiment library is applied to the given region according to the start conditions of the stages associated with the component.

31. The computer program product of claim 30, wherein executing the set of experiments includes:
translating the process design into instructions for one or more automated devices; and
executing the set of experiments using the one or more automated devices according to the instructions.

32. The computer program product of claim 30, wherein:
the plurality of experiment stages includes an experiment stage having a process data event type having a start condition based on a target value of a specified parameter; and
executing the set of experiments includes monitoring the specified parameter for one or more of the regions during execution of the set of experiments, and applying the component or components associated with the experiment stage according to the corresponding component profile when a monitored value of the specified parameter reaches the target value.

33. The computer program product of claim 32, wherein:
applying the component or components includes applying the component or components associated with the experiment stage to the corresponding regions according to the corresponding component profile only when a monitored value of the specified parameter reaches the target value for all members of the experiment library.

34. The computer program product of claim 32, wherein:
applying the component or components includes applying the component or components associated with the experiment stage to a given region according to the corresponding component profile when a monitored value of the specified parameter reaches the target value for the given region of the experiment library.

35. A computer-implemented process control system, comprising:
a multi-well reactor configured to perform an automated or semi-automated process at a plurality of regions of an experiment library, the process involving the application of a plurality of components at the plurality of regions; and
a programmable processor configured to execute a program of instructions operable to cause the programmable processor to perform operations comprising:
associating one or more components with each of the plurality of regions, each of the components representing a material or process parameter to be applied at the associated regions;
defining a plurality of experiment stages, each of the plurality of experiment stages having one or more associated event types selected from a plurality of predetermined event types, the one or more event types defining a start condition for the corresponding stage;
for each of the plurality of regions of the experiment library, associating each of the associated components with one or more of the experiment stages; and
generating a plurality of component profiles representing processes to be performed at the regions of the experiment library, each component profile describing the application over time of one or more of the components associated with a corresponding region or regions according to the associated experiment stages.

36. The system of claim 35, wherein:
the plurality of predetermined event types includes a stage event specifying a start condition for the corresponding experiment stage based on another stage in the plurality of experiment stages.

37. The system of claim 35, wherein:
the plurality of predetermined event types includes a process data event specifying a start condition for the corresponding experiment stage based on a value of a parameter being monitored during the process.

38. The system of claim 35, wherein:
the plurality of predetermined event types includes a user event specifying a start condition for the corresponding experiment stage based on user input during the process.

39. The system of claim 35, wherein:
the plurality of predetermined event types includes a stage event specifying a start condition for the corresponding experiment stage based on another stage in the plurality of experiment stages, a process data event specifying a start condition for the corresponding experiment stage based on a value of a parameter being monitored during the process, a user event specifying a start condition for the corresponding experiment stage based on user input during the process, and a clock event specifying a start condition for the corresponding experiment stage based on a specified time in the process.

40. The system of claim 35, wherein:
defining the experiment stages includes defining one or more experiment stages having a compound start condition defined by a plurality of the event types.

41. The system of claim 35, wherein:
associating the one or more components with the plurality of regions includes receiving a plurality of component mappings, each mapping assigning an amount or amounts of one of the components to one or more of the plurality of regions; and
associating the components with the experiment stages includes, for each of the component mappings and each of the corresponding regions, associating the corresponding component amount or amounts with one or more of the experiment stages.

42. The system of claim 35, wherein:
associating the components with the experiment stages includes, for a given region, associating a first amount of one of the components with a first stage of the plurality of experiment stages and a second amount of the component with a second stage of the plurality of experiment stages.

43. The system of claim 35, wherein:
the experiment library includes a plurality of library members, each library member representing a location at which an experiment in a set of experiments can be performed; and
one or more of the components are associated with one or more regions of the experiment library that represent groups including a plurality of the library members.

44. The system of claim 43, wherein:
defining the experiment stages includes defining one or more experiment stages having a start condition that depends on an occurrence of an event for each of the library members in one or more groups represented by one or more of the regions.

45. The system of claim 35, the processor being configured to execute a program of instructions operable to cause the programmable processor to perform operations further comprising:
displaying a graphical representation of one or more of the component profiles to a user.

46. The system of claim 35, the processor being configured to execute a program of instructions operable to cause the programmable processor to perform operations further comprising:
generating a process design comprising electronic data representing the components, experiment stages and processes.

47. The system of claim 35, the processor being configured to execute a program of instructions operable to cause the programmable processor to perform operations further comprising:
executing in the multi-well reactor a set of experiments by applying the components to the regions of the experiment library according to the component profiles, such that each component associated with a given region of the experiment library is applied to the given region according to the start conditions of the stages associated with the component.

48. The system of claim 47, wherein:
the plurality of experiment stages includes an experiment stage having a process data event type having a start condition based on a target value of a specified parameter; and
executing the set of experiments includes monitoring the specified parameter for one or more of the regions during execution of the set of experiments, and applying the component or components associated with the experiment stage according to the corresponding component profile when a monitored value of the specified parameter reaches the target value.

49. The system of claim 48, wherein:
applying the component or components includes applying the component or components associated with the experiment stage to the corresponding regions according to the corresponding component profile only when a monitored value of the specified parameter reaches the target value for all members of the experiment library.

50. The system of claim 49, wherein:
applying the component or components includes applying the component or components associated with the experiment stage to a given region according to the corresponding component profile when a monitored value of the specified parameter reaches the target value for the given region of the experiment library.
